(19) United States
(12) Patent Application Publication
(10) Pub. No.: US 2007/0094380 A1
(43) Pub. Date: Apr. 26, 2007

(54) Method and apparatus for collocating application monitoring reports with web applications

(76) Inventors: Samuel Fu, Austin, TX (US); Joshua Gunnar, Austin, TX (US); Andrew Jason Lavery, Austin, TX (US); David Lee Skeen, Cedar Park, TX (US)

Correspondence Address: IBM CORP (YA);C/O YEE & ASSOCIATES PC, P.O. BOX 802333, DALLAS, TX, 75380, US

(21) Appl. No.: 11/255,154

(22) Filed: Oct. 20, 2005

(51) Int. Cl. G06F 15/173

(52) U.S. Cl. 709/224

(57) ABSTRACT

A computer implemented method, apparatus, and computer usable program code to display a Web site with its corresponding monitoring information. A determination is made as to whether a user at a client data processing system is permitted access monitoring information for a Web site. The Web page is retrieved to form a retrieved Web page in response to a request for a Web page from the Web site. Monitoring information is associated with the retrieved Web page from associated monitoring information if the user is permitted to access the monitoring information to form collocated content. The collocated content is sent to the user at the client data processing system.

### BACKGROUND OF THE INVENTION

1. Field of the Invention

The present invention relates generally to an improved data processing system and in particular to a method and an apparatus for monitoring resource usage. Still more particularly, the present invention relates to a computer implemented method, apparatus, and computer usable program code for presenting monitoring information for a Web site.

2. Description of the Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized both communications and commerce, as well as, being a source of both information and entertainment. For many users, email is a widely used format to communicate over the Internet. Additionally, the Internet also is used for real-time voice conversations.

With respect to transferring data over the Internet, the World Wide Web environment is used. This environment also is referred to simply as “the Web”. The Web is a mechanism used to access information over the Internet. In the Web environment, servers and clients effect data transaction using the hypertext transfer protocol (HTTP), a known protocol for handling the transfer of various data files, such as, text files, graphic images, animation files, audio files, and video files.

On the Web, the information in various data files is formatted for presentation to a user by a standard page description language, the hypertext markup language (HTML). Documents using HTML also are referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as, the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for selection of various functions through menus and allows for navigation. For example, a menu may allow a user to perform various functions, such as saving a file, opening a new window, displaying a history, and entering a URL.

Administrators of Web sites are interested in monitoring the performance of applications used to present the Web sites to users. In monitoring the performance of a Web site, an application is used to monitor the Web applications used to generate the Web site to ensure that the performance of the Web site is adequate. Application monitoring systems provide a console that is separate from the Web application that is being monitored. An example of an application monitoring system is the IBM® Tivoli Composite Application Management (TCAM). This product is available from International Business Machines Corporation.

These types of systems utilize a console to allow a customer or administrator to configure which application should be monitored as well as viewing monitoring reports for the Web applications selected for monitoring. One drawback of these application monitoring systems is that the performance reports on the Web application are decoupled from the Web site itself. As a result, a customer user may have difficulty in correlating the monitoring system reports with individual pages of the Web site. Further, a customer or administrator also is required to learn how to use the application monitoring system to view the monitoring information for their Web application in addition to knowing how to use the Web application.

Therefore, it would be advantageous to have an improved computer implemented method, apparatus, and computer usable program code for viewing monitoring reports for Web sites.

### SUMMARY OF THE INVENTION

The present invention provides a computer implemented method, apparatus, and computer usable program code to display a Web site with its corresponding monitoring information. A determination is made as to whether a user at a client data processing system is permitted access monitoring information for a Web site. The Web page is retrieved to form a retrieved Web page in response to a request for a Web page from the Web site. Monitoring information is associated with the retrieved Web page from associated monitoring information if the user is permitted to access the monitoring information to form collocated content. The collocated content is sent to the user at the client data processing system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system in accordance with an illustrative embodiment of the present invention;

FIG. 3 is a diagram illustrating components used for collocating application monitoring reports with Web applications in accordance with an illustrative embodiment of the present invention;

FIG. 4 is a diagram illustrating collocated content displayed within a Web browser in accordance with an illustrative embodiment of the present invention;

FIG. 5 is a flowchart of a process for presenting application monitoring reports with Web applications in accordance with an illustrative embodiment of the present invention; and

FIG. 6 is a flowchart of a process for updating monitoring information in accordance with an illustrative embodiment of the present invention.

### DETAILED DESCRIPTION OF THE PREFERRED EMBODIMENT

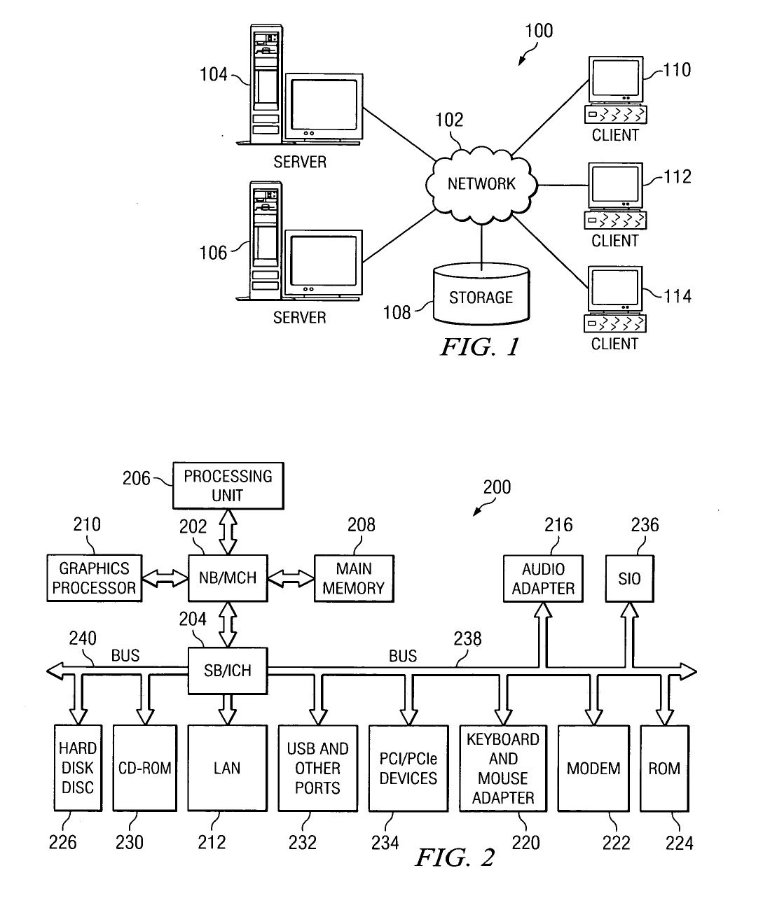

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located. In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for presenting monitoring reports to a user. In particular, the aspects of the present invention provide a mechanism for collocating application monitoring reports with Web applications. In other words, a monitoring report is combined with the Web application content and presented to the user in a fashion that allows the user to correlate the information with different portion of a Web site, such as Web pages.

In one illustrative embodiment, a determination is made as to whether a user is permitted to access monitoring information for a Web site. A Web page is retrieved in response to a request for a Web page from the Web site. Monitoring information is associated with the Web page to form collocated content. In other words, the monitoring information in the Web page is put together or associated in a manner to allow a user to view the monitoring information in association with the Web page. In this manner, the user may see the particular monitoring information for a Web page without having to employ a separate console or application. The collocated content is then sent to the user for viewing.

With the aspects of the present invention, the performance and availability monitoring information for Web application may be presented together with the Web application itself without requiring the user to employ a separate application. In fact, the user does not even need to know how to use the Web application. For example, a user may log into the Web site. If the Web site detects that this particular user should see monitoring information for the Web site, the Web site provides the user access to this information. This access is provided without having to imitate another application, such as an application monitoring system.

As this user navigates the Web site, the user is able to view performance information for the corresponding pages that are being viewed. This type of system allows the user to clearly see how the monitoring information gathered by the application monitoring system is related to the Web site. As a result, the user does not have to learn the particular interface or application monitoring system functions to view the monitoring reports. In this manner, the user may visualize a Web site's performance as the user uses the Web site itself.

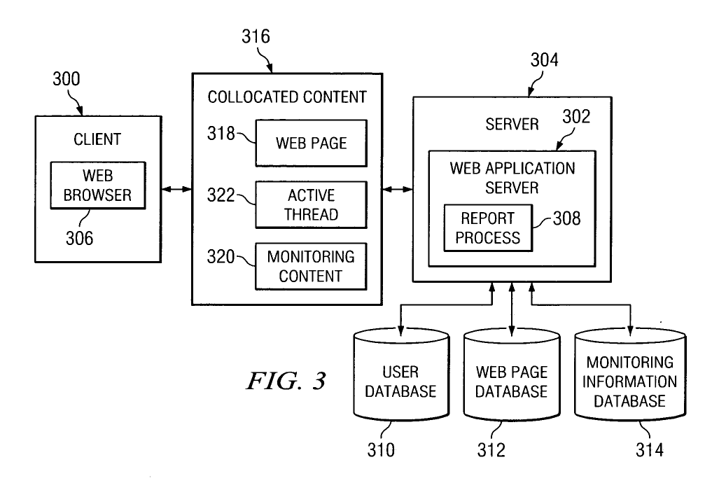

With reference now to FIG. 3, a diagram illustrating components used for collocating application monitoring reports with Web applications is depicted in accordance with an illustrative embodiment of the present invention. In this example, a user at client 300 may log onto Web application server 302 located on server 304. Web application server 302 provides processes to present a Web site to various users in this example.

A web application server, such as Web application server 302, can also host “Web Services”. Web Services utilize Simple Object Access Protocol (SOAP) to provide a programmatic interface to a service. For instance, a Web server could host a Web service that allows businesses to reserve a rental car. The Web service is used by another Web application, or even by a standalone non-Web application. A browser does not make a direct request to a Web service, but rather a software component such as a Java class, a Visual Basic, or a shell script written in Perl would invoke a Web service through an API. Web services do require monitoring. When the Web service is used in order to generate a Web page, the performance of the Web service can be included in the overall performance of the Web page.

This log on to the Web site may be accomplished using Web browser 306. When logging onto Web application server 302, this particular process uses report process 308. Report process 308 determines whether the user is one that should be given access to monitoring information. Report process 308 makes this identification through accessing user database 310. This database contains a list of users that may access the Web site provided by Web application server 302.

Additionally, this database also indicates users that may access monitoring information. Upon determining that the user at client 300 should be able to access monitoring information, report process 308 retrieves the Web page provided at log on from Web page database 312. In these examples, report process 308 checks on a per page basis whether the user is authorized to see monitoring data for that page.

This type of checking occurs in the event that a user is able to see monitoring data for certain pages of the Web site but not other pages. Moreover, report process 308 also retrieves monitoring information for that particular page for monitoring information database 314. Fine-grained control of what monitoring information is presented to which users may be used. Report process 308 can utilize user database 310 to determine what type of monitoring information should be presented to the users. Some users may have restricted access to monitoring information. Other users may have unrestricted access and be able to view all monitoring information.

Monitoring information database 314 contains information gathered through the use of the Web site. This information is gathered in these illustrative examples using application monitoring systems, such as IBM® Tivoli Composite Application Management (TCAM). The information gathered by this type of system is placed into monitoring information database 314.

Web page database 312 and monitoring information database 314 may be located at server 304 or at a remote location accessed by server 304. In the illustrative examples, this monitoring information is collocated or put together for display in a single instance of a browser, such as Web browser 306. In these illustrative examples, the Web page is displayed in one frame while the monitoring information for the Web page is displayed in a second frame. This information is modified to generate the display of the information in the frames by report process 308 in these examples. The processing of the Web page and the monitoring information form collocated content, which is returned by Web application server 302 to Web browser 306 in the form of collocated content 316.

In this example, collocated content 316 contains Web page 318, monitoring content 320, and active thread 322. When report process 308 formats the monitoring information in Web page database 312 for return to client 300, code, such as active thread 322, is included within the monitoring information. This active thread is used to detect when changes occur to the Web page being displayed by Web browser 306. When such a change occurs, active thread 322 requests new monitoring information that corresponds to the new Web page. This information may be sent all at the same time to client 300 for display within Web browser 306. Active thread 322 is displayed in the same frame as monitoring content 320. Active thread 322 detect when the frame in which Web page 318 changes to display another Web page.

In this depicted example, active thread 322 requests the monitoring information for the new page being displayed in the frame when such a change occurs. Alternatively, Web application server 302 may send the Web page first for display in the first frame and then send the monitoring information for display in the second frame. Further, the Web page from Web page database 312 may be a static Web page or the Web page may be dynamically generated from content within Web page database 312.

Collocated content 316 is displayed within Web browser 306 in frames at client 300. In this manner, the user is able to see the monitoring information associated with the particular Web page being displayed. This monitoring information contains, for example, hits, common page loads, number of visitors, visitor date, time, average time to generate the Web page over the last hour, and availability of the page (whether the page has been down) in the last hour, the first date and time the page has been visited by the visitor, location of visitor access, referring links, unique visitors, returning visitors, visitor length, browser statistics, operating system used by the visitor, and Java™ script statistics for the visitor.

This and other information about the Web page may be displayed in conjunction or in association with the Web page. Further, other statistical information about the Web server application other than those relating to the Web page also may be displayed depending on the particular implementation. Examples include the amount of memory currently used by the Web application, or by the Web application server itself. The number of users currently logged into the Web application and processor load being generated by the Web application. Although the illustrative examples provide this information through a log on occurring on the Web site, the aspects of the present invention may be applied to other Web sites that may not have a login page. For instance, an online bookseller may not require login to use the Web site (except perhaps during the final steps of placing an order), but the bookseller still wants to monitor the Web site.

In order to view monitoring information about a Web site, a user needs to login so that report process 308 monitoring software knows that this user is authorized to view monitoring information. This can be accomplished for Web sites that do not have a login page by just letting the user login to a generic report process login page on Web application sever 302. After logging into the report process page, the user's Web browser session contains information about what monitoring data the user is authorized to view. Then, the user can use that same session and go browse the bookseller Web site that does not have a login page. Web application server 302 can look in the session as Web application server 302 is serving up the bookseller Web site. If the session contains the appropriate reporting authorization, Web application server 302 collocates reporting information with the Web pages that are returned. In either case, the user's Web browser session will contain information used by report process 308 while the user visits the Web site in whose performance the user is interested. The report process can then return the correct monitoring information along with the Web site pages.

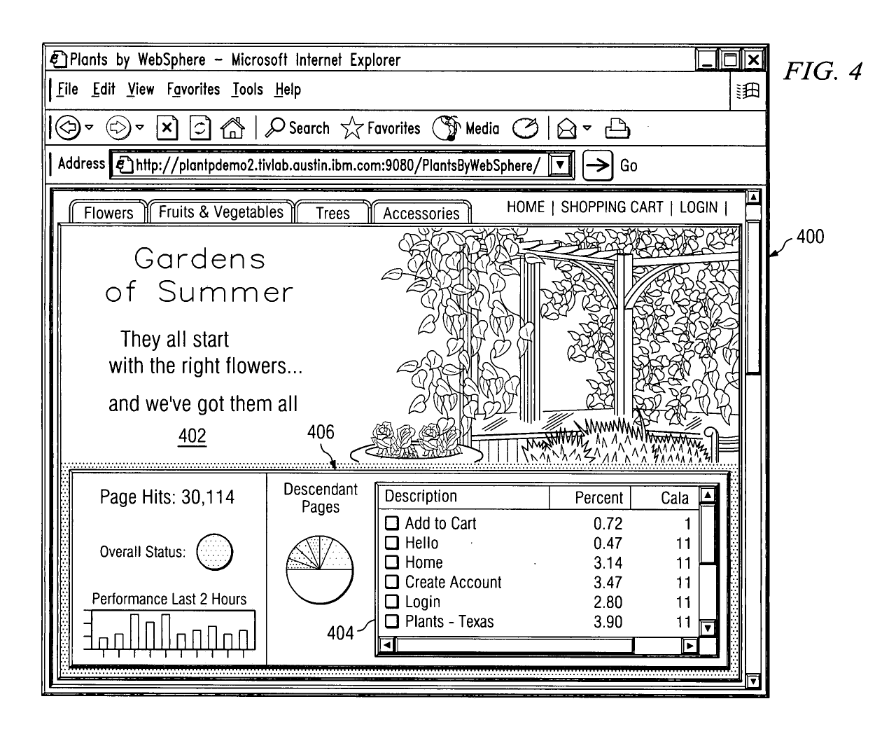

Turning next to FIG. 4, a diagram illustrating collocated content displayed within a Web browser is depicted in accordance with an illustrative embodiment of the present invention. Window 400 is an example of a window presented by a Web browser, such as Web browser 306 in FIG. 3. The information presented within window 400 is an example of collocated content; such as collocated content 316 in FIG. 3. In this example, the Web page is displayed in Web page frame 402 while monitoring information is displayed in information frame 404. In this particular example, the monitoring information is displayed in information frame 404 in a location at the bottom of window 400. In this example, the monitoring information is highlighted with border 406, which may have a color to bring attention to the monitoring information.

In these examples, information frame 404 contains an active thread, such as active thread 322 in FIG. 3 that listens for changes in Web page frame 402. When changes occur in Web page frame 402, such as a new Web page being retrieved, information frame 404 retrieves corresponding information for the new Web page and updates this particular frame with the new monitoring information. Alternatively, a second window may be launched containing the monitoring information while the first window for the Web browser contains the display of the Web site. The particular type of display illustrated in FIG. 4 is not meant as an architectural limitation to how information can be displayed.

In this manner, a user that is permitted to have access to monitoring information may view different portions of the Web site with the monitoring information for those portions of the Web site being presented in association with the portion of the Web site being displayed. As a result, the user may use the Web site itself to visualize the performance of the Web site without having to use a second application to access this information and attempt to correlate the information with different portions of the Web site.

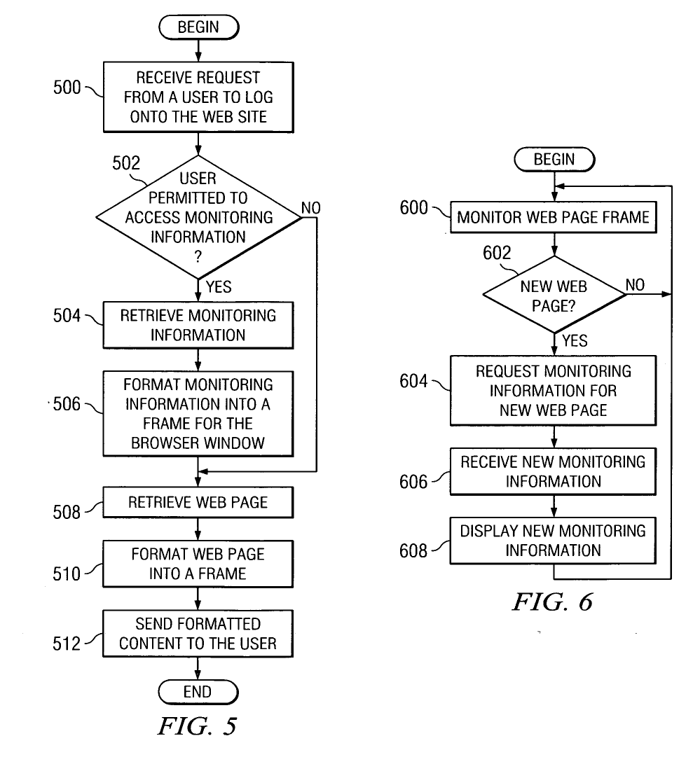

Turning now to FIG. 5, a flowchart of a process for presenting application monitoring reports with Web applications is depicted in accordance with an illustrative embodiment of the present invention. The process illustrated in FIG. 5 is implemented in a Web application server. In particular, the process in FIG. 5 may be implemented as part of report process 308 in FIG. 3.

The process begins by receiving a request from a user to log onto the Web site (step 500). Thereafter, a determination is made as to whether the user is permitted to access monitoring information (step 502). If the user is permitted to access monitoring information, the process retrieves the monitoring information (step 504). In step 504, the monitoring information is retrieved for the Web page that will be returned if the user has successfully logged onto the Web site. Next, the process formats the monitoring information into a frame for the browser window (step 506). This frame is a frame, such as information frame 404 in FIG. 4. In formatting the monitoring information, an active thread is added for use in the frame. This active thread is employed to detect when a change in the frame displaying the Web page occurs. This active thread is used to request monitoring information for the new Web page that is displayed in the frame.

The process retrieves the Web page (step 508). The Web page is formatted for display in a frame (step 510). In step 510, the Web page in displayed in a frame, such as Web page frame 402 in FIG. 4. The process then sends the formatted content to the user (step 512) with the process terminating thereafter.

With reference again to step 502, if the user is not permitted to access monitoring information, the process proceeds directly to step 508 to retrieve the Web page for the user. In this instance, no monitoring information is retrieved or returned to the user for viewing because this user is not authorized to access the information.

Turning now to FIG. 6, a flowchart of a process for updating monitoring information is depicted in accordance with an illustrative embodiment of the present invention. The process illustrated in FIG. 6 may be implemented in an active thread within a frame displaying the monitoring content, such as active thread 322 in FIG. 3. The process begins by monitoring the Web page frame for changes (step 600). Monitoring in step 600 can be accomplished a number of different ways. One example is for a thread in monitoring frame 404 in FIG. 4 to poll the content of Web page frame 402 in FIG. 4 to see if the content has changed since the monitoring information was retrieved.

A determination is made as to whether the monitoring detects a change in the Web page frame to a new Web page (step 602). If a change to a new Web page is not detected, the process returns to step 600.

Otherwise, monitoring information for the new Web page in the Web page frame is retrieved (step 604). In step 604, the active thread sends a request to the report process within the Web application server to retrieve the new monitoring information for the new Web page. The process receives the monitoring information from the Web application server (step 606) and displays the new monitoring information (step 608). The process then returns to step 600 as described above.

Alternatively, the monitoring information may be returned each time a new Web page is requested by the Web browser rather than having an active thread monitor for changes. In this type of implementation, the report process retrieves the monitoring information for each Web page requested by the user each time a request is made. In this instance, the process in FIG. 6 may be implemented such that the process is initiated each time a request is received from a user that has logged onto the Web site.

Thus, the aspects of the present invention allow a user to view monitoring information for different portions of a Web site while the user traverses or uses the Web site. This monitoring information is displayed in association with the particular portion of the Web site being viewed. In the illustrative examples, the particular portions of the Web site being viewed are Web pages. The monitoring information is displayed in association with the Web page that is retrieved by the user. In these examples, the display is in a frame in the same browser. Of course, the monitoring information may be displayed in other manners, such as, in a separate window.

In this manner, the user is not required to learn how to use an application monitoring system to view monitoring information about the Web site. The display of the monitoring information in association with Web pages while a user is traversing the different portions of the Web site allows the user to see how the monitoring information gathered by an application monitoring system is related to the Web site.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting monitoring reports, the computer implemented method comprising:
determining whether a user at a client data processing system is permitted access to monitoring information for a Web site;
responsive to a request for a Web page from the Web site, retrieving the Web page to form a retrieved Web page;
associating monitoring information with the retrieved Web page to form associated monitoring information if the user is permitted to access the monitoring information to form collocated content; and
sending the collocated content to the client data processing system.

2. The computer implemented method of claim 1 further comprising:
presenting the collocated content in a browser at the client data processing system.

3. The computer implemented method of claim 2, wherein the presenting step comprises:
displaying the Web page and the associated monitoring information in frames.

4. The computer implemented method of claim 1, wherein the sending step comprises:
formatting the Web page for display in a first frame in a window for a browser to form first formatted information;
formatting the monitoring information for display in a second frame in the window for the browser to form second formatted information; and
sending the first formatted information and the second formatted information to the user for display in the window for the browser.

5. The computer implemented method of claim 1, wherein the associating step comprises:
monitoring the first frame for a change to display a new Web page; and
responsive to detecting the change, retrieving new monitoring information associated with the new Web page.

6. The computer implemented method of claim 5, wherein monitoring and displaying steps are performed by an active thread in the second frame.

7. The computer implemented method of claim 1, wherein the determining step is initiated in response to the user requesting to logon to the Web site.

8. The computer implemented method of claim 1, wherein the monitoring information comprises information for the Webpage.

9. The computer implemented method of claim 7, wherein the monitoring information further comprises information for the Web site.

10. The computer implemented method of claim 1, wherein the retrieving step comprises:
retrieving content for the Web page to form retrieved content; and
dynamically creating the Web page using the retrieved content.

11. A computer program product comprising:
a computer usable medium having computer usable program code for presenting monitoring reports, the computer program product including:
computer usable program code for determining whether a user at a client data processing system is permitted access to monitoring information for a Web site;
computer usable program code, responsive to a request for a Web page from the Web site, for retrieving the Web page to form a retrieved Web page;
computer usable program code for associating monitoring information with the retrieved Web page to form associated monitoring information if the user is permitted to access the monitoring information to form collocated content; and
computer usable program code for sending the collocated content to the client data processing system.

12. The computer program product of claim 11 further comprising:
computer usable program code for presenting the collocated content in a browser at the client data processing system.

13. The computer program product of claim 12, wherein the computer usable program code for presenting the collocated content in a browser at the client data processing system comprises:
computer usable program code for displaying the Web page and the associated monitoring information in frames.

14. The computer program product of claim 11, wherein the computer usable program code for sending the collocated content to the client data processing system comprising:
computer usable program code for formatting the Web page for display in a first frame in a window for a browser to form first formatted information;
computer usable program code for formatting the monitoring information for display in a second frame in the window for the browser to form second formatted information; and
computer usable program code for sending the first formatted information and the second formatted information to the user for display in the window for the browser.

15. The computer program product of claim 11, wherein the computer usable program code for associating monitoring information with the retrieved Web page to form associated monitoring information if the user is permitted to access the monitoring information for form collocated content comprises:
computer usable program code for monitoring the first frame for a change to display a new Web page; and
computer usable program code, responsive to detecting the change, for retrieving new monitoring information associated with the new Web page.

16. The computer program product of claim 15, wherein computer usable program code for monitoring the first frame for a change to display a new Web page and the computer usable program code, responsive to detecting the change, for displaying new monitoring information associated with the new Web page in the second frame are performed by an active thread in the second frame.

17. The computer program product of claim 11, wherein the computer usable program code for determining whether a user at a client data processing system is permitted access monitoring information for a Web site is initiated in response to the user requesting to logon to the Web site.

18. A data processing system comprising:
a bus;
a communications unit connected to the bus;
a memory connected to the bus, wherein the memory includes a set of instructions; and
a processor unit connected to the bus, wherein the processor unit executes the computer usable code to determine whether a user at a client data processing system is permitted access to monitoring information for a Web site; retrieve the Web page to form a retrieved Web page in response to a request for a Web page from the Web site; associate monitoring information with the retrieved Web page to form associated monitoring information if the user is permitted to access the monitoring information to form collocated content; and send the collocated content to the client data processing system.

19. The data processing system of claim 18, wherein the processor unit further executes the computer usable code to present the collocated content in a browser at the client data processing system.

20. The data processing system of claim 19, wherein the processor unit further executes the computer usable code to display the Web page and the associated monitoring information in frames.
